(19) United States
(12) Patent Application Publication
(10) Pub. No.: US 2019/0141107 A1
(43) Pub. Date: May 9, 2019

(54) Transcoder Assignment for Real-time Text

(71) Applicant: T-Mobile USA, Inc., Bellevue, WA (US)

(72) Inventors: Boris Antsev, Bothell, WA (US); Yasmin Karimli, Kirkland, WA (US); Hsin-Fu Henry Chiang, Bellevue, WA (US)

(21) Appl. No.: 15/806,118

(22) Filed: Nov. 7, 2017

(51) Int. Cl. H04L 29/06; H04M 11/04; H04W 8/22

(52) U.S. Cl. CPC H04L 65/607; H04L 65/1016; H04W 8/22; H04L 65/1096; H04M 11/04; H04L 65/1069

(57) ABSTRACT

Transcoder assignment for real-time text (RTT) is described. A service provider can send an offer to establish a RTT call with a first device to an alternate service provider associated with a second device. The alternate service provider can transmit the offer to the second device, which can decline the offer. The alternate service provider can receive a response indicating that the second device declined the offer and, based on receiving the response, can determine whether the second device supports RTT. If the second device does not support RTT, the alternate service provider can add an indictor to the response that indicates that the second device does not support RTT. The alternate service provider can send the response (and the indicator) to the service provider, and the service provider can establish the RTT call without assigning a transcoder to the RTT call.

### BACKGROUND

Teletypewriter (TTY) service enables real-time conversation between two persons having devices that are capable to facilitate such a real-time conversation (e.g., Baudot-capable devices). TTY services are supported through Circuit Switched (CS) public networks. Real-time text (RTT) describes the ability to instantly communicate text as it is typed, as opposed to after a sentence or thought is completed, in the manner of instant messaging. RTT can be signaled over internet protocol (IP) networks and can be optionally combined in any combination with audio and/or video. When such a combined service is provided by an IP Multimedia Subsystem (IMS) network, it is referred to as Global Text Telephony (GTT).

TTY services can be provided over IP between operators' networks through the use of GTT, which enables alternating and/or simultaneous audio and/or video and RTT media streams. Additional details associated with the support of TTY service over IP using GTT can be found in the Alliance for Telecommunication Industry Solutions (ATIS) technical specification 1000068.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an environment for determining whether to assign a transcoder to a real-time text (RTT) call.

FIG. 2 illustrates an environment for determining whether to assign a transcoder to a RTT call.

FIG. 3 illustrates an example process for determining whether to assign a transcoder to a RTT call.

FIG. 4 illustrates an example process, performed by a service provider, for determining whether a target device accepts an RTT call.

FIG. 5 illustrates an example process, performed by a service provider, for determining whether a device supports RTT and sending a response indicating whether the device supports RTT.

FIG. 6 illustrates an example process, performed by a service provider, for determining whether to add a feature tag to a response declining an offer to establish an RTT call.

FIG. 7 illustrates an example process, performed by a service provider, for determining whether to assign a transcoder to a RTT call based on an indication of a state of RTT functionality associated with a target device.

### DETAILED DESCRIPTION

Transcoder assignment for real-time text (RTT) is described herein. As described above, teletypewriter (TTY) service enables real-time conversation between two persons having devices that are capable to facilitate such a real-time conversation (e.g., Baudot-capable devices). TTY services are supported through Circuit Switched (CS) public networks. RTT describes the ability to instantly communicate text as it is typed, as opposed to after a sentence or thought is completed, in the manner of instant messaging. RTT can be signaled over internet protocol (IP) networks and can be optionally combined in any combination with audio and/or video. When such a combined service is provided by an IP Multimedia Subsystem (IMS) network, it is referred to as Global Text Telephony (GTT).

TTY services can be provided over IP between operators' networks through the use of GTT, which enables alternating and/or simultaneous audio and/or video and RTT media streams. Additional details associated with the support of TTY service over IP using GTT can be found in the Alliance for Telecommunication Industry Solutions (ATIS) technical specification 1000068.

Existing techniques for facilitating GTT require service providers that are transmitting outbound RTT calls (RTT combined with audio and/or video) to transcode nearly every outbound RTT call to ensure that target devices can receive the RTT calls. For the purpose of this discussion, transcoding describes a conversion process of one encoding to another encoding. That is, to ensure that a target device can participate in an RTT call from another device, existing techniques require a service provider facilitating the outgoing RTT call to transcode the RTT call into a new encoding (e.g., Baudot). In at least one example, when transcoding is introduced, audio and/or video and RTT media streams can be transcoded to a particular codec (e.g., G.711) via an interworking function, as described below. As a result, the target device can participate in the RTT call despite not supporting RTT functionality.

In some examples, transcoding is necessary. However, in other examples, transcoding is unnecessary and transcoding every outbound RTT call is computationally expensive. Techniques described herein leverage an indicator, such as a feature tag, to determine when a transcoder is to be assigned to an outgoing RTT call and when a transcoder need not be assigned to an outgoing RTT call. If a transcoder is not required (e.g., no transcoder is assigned to an outgoing RTT call), the service provider transmitting an outbound RTT call can refrain from transcoding the outbound RTT call, thereby saving computational resources.

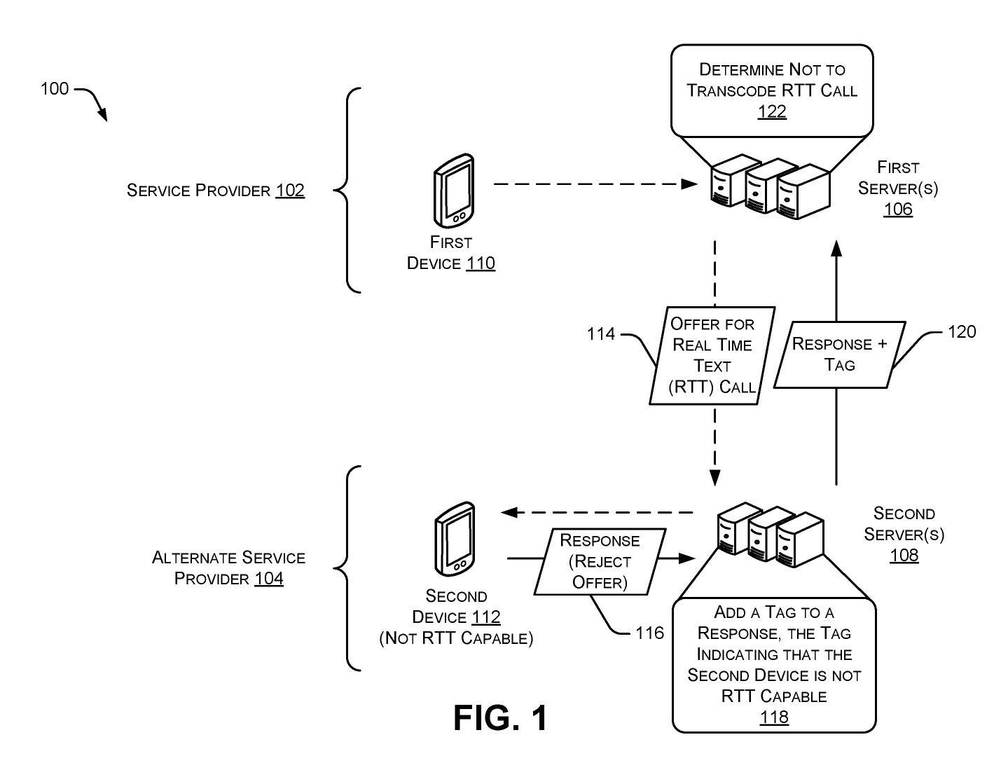

FIG. 1 illustrates an environment 100 for determining whether to assign a transcoder to a RTT call. The environment 100 includes two service providers: a service provider 102 and an alternative service provider 104. While the environment 100 includes two service providers, any number of service providers can be included in such an environment. The service provider 102 and/or alternative service provider 104 can provide services, such as telecommunication services, to one or more devices that subscribe to such services (e.g., via establishment of an account with the respective service provider 102 or 104). In some examples, the service provider 102 and the alternate service provider 104 can be a same service provider or partner service providers offering the same and/or similar services to different customers. In at least one example, the service provider 102 or the alternate service provider 104 can be a non-IP multimedia subsystem (IMS)-enabled emergency services service provider.

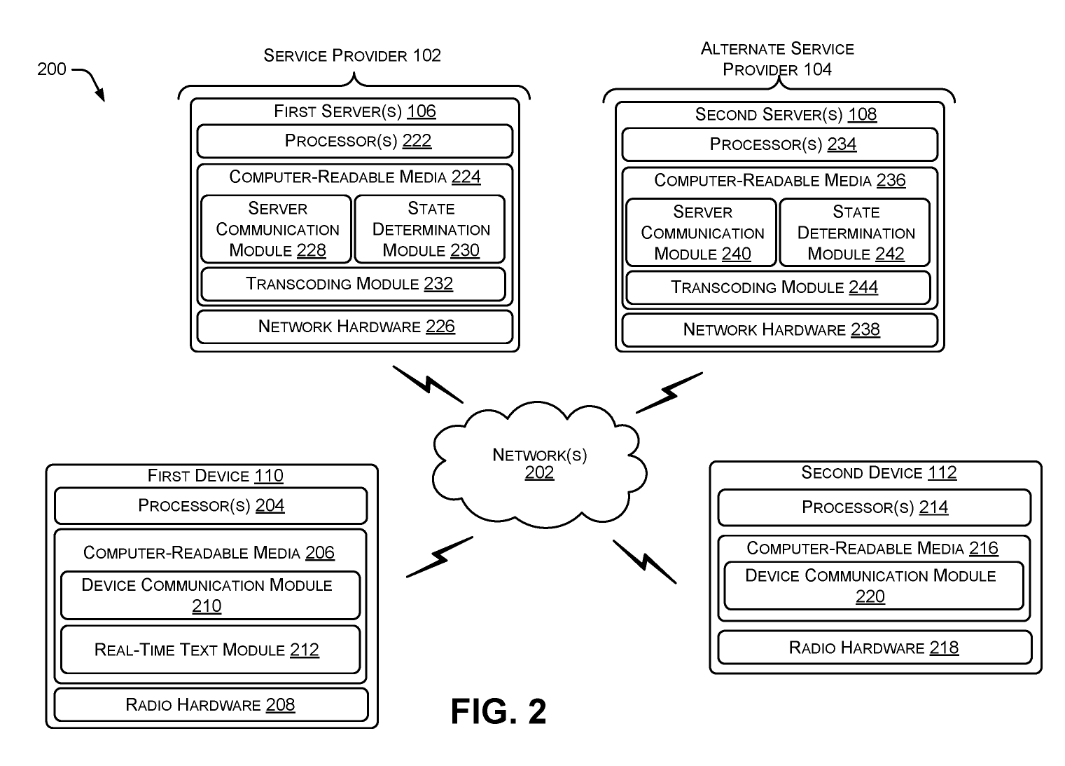

In at least one example, the service provider 102 and the alternative service provider 104 each can be associated with one or more servers. That is, the service provider 102 can be associated with first server(s) 106 and the alternate service provider 104 can be associated with second server(s) 108. Actions attributed to the service provider 102 or the alternate service provider 104 can be attributed to the first server(s) 106 or the second server(s) 108, respectively. Additional information associated with the first server(s) 106 and the second server(s) 108 is provided below with respect to FIG. 2.

The environment 100 can additionally include one or more devices that can be supported by the service provider 102 or the alternate service provider 104. As an example, a first device 110 can subscribe to services offered by the service provider 102 and a second device 112 can subscribe to services offered by the alternate service provider 104. While a single device is shown as being associated with each service provider, any number of devices can be associated with the service provider 102 and/or the alternate service provider 104.

In at least one example, the first device 110 can transmit an offer 114 (e.g., session initiation protocol (SIP) invite) to establish a RTT call with the second device 112 to the second device 112. As described above, for the purpose of this discussion, a RTT call can comprise a RTT that is combined with audio and/or video. That is, the RTT call can include an audio media stream and a RTT media stream. For the purpose of this discussion, the RTT media stream can correspond to the text media stream. Additionally and/or alternatively, a RTT call can include a video media stream and a RTT media stream. The first device 110 can transmit the offer 114 to the second device 112 via the first server(s) 106 and the second server(s) 108. That is, the offer 114 can be transmitted from the first device 110 to the first server(s) 106, from the first server(s) 106 to the second server(s) 108, and from the second server(s) 108 to the second device 112.

In some examples, the second device 112 can reject the offer 114. For instance, the second device 112 can reject the offer 114 because the second device 112 is not configured to receive RTT calls in such an encoding or the RTT functionality on the second device 112 is disabled (e.g., the second device 112 does not support RTT). If the second device 112 is RTT capable, but the RTT functionality is disabled, the second device 112 can transmit a response (e.g., SIP 180 ringing) to the second server(s) 108 that it does not accept the offer 114 and the response can include an indicator (e.g., a feature tag) indicating that the second device 112 has disabled RTT functionality, as described in ATIS technical specification 0700029. However, if the second device 112 is not RTT capable, the second device 112 can transmit a response 116 (e.g., SIP 180 ringing) to the second server(s) 108 that it does not accept the offer 114, and, in such an example, the response 116 will lack the indicator (e.g., the feature tag) because the second device 112 is not RTT capable.

Responsive to receiving the response 116 from the second device 112 that the second device 112 does not accept the offer 114 and determining that the response 116 does not include the indicator, the second server(s) 108 can determine that the second device 112 is not capable of supporting RTT. That is, the second server(s) 108 can determine whether the second device 112 supports RTT based on the presence or absence of the indicator. In at least one example, based on determining that the second device 112 does not support RTT, the second server(s) 108 can add a feature tag (abbreviated as “tag” in FIG. 1) to the response 116, as illustrated in block 118. The second server(s) 108 can transmit the response and the tag (e.g., modified response 120) with the feature tag to the first server(s) 106. The response 116 can indicate that the second device 112 rejected the offer 114 and the feature tag associated with the modified response 120 can indicate that the second device 112 is not RTT capable.

In at least one example, the second server(s) 108 can determine one or more criteria associated with the second device 112 prior to determining whether to add the feature tag to the response 116 to determine whether the second device 112 may support TTY. For instance, the second server(s) 108 can determine a cellular technology associated with the second device 112. If the cellular technology is a technology that does not support TTY (e.g., Voice Over Long-term Evolution (VoLTE)), the second server(s) 108 can determine to add the feature tag to the response 116. However, if the cellular technology is a technology that may support TTY, the second server(s) 108 can refrain from adding the feature tag to the response 116. Additionally and/or alternatively, the second server(s) 108 can determine a device type associated with the second device 112, and can determine whether the second device 112 may support TTY based on the device type.

The first server(s) 106 can receive the modified response 120 and can determine whether to transcode the RTT call based on the modified response 120. In an example, the presence of the feature tag in the modified response 120 allows the first server(s) 106 to differentiate between scenarios where a target device (e.g., the second device 112) does not support RTT or TTY (e.g., no transcoder needs to be assigned) and scenarios where a target device (e.g., the second device 112) may support RTT and/or does not support RTT but may support TTY (e.g., a transcoder needs to be assigned). Accordingly, due to the presence of the feature tag, the first server(s) 106 can refrain from transcoding the RTT call, as illustrated in block 122. That is, the first server(s) 106 can refrain from assigning a transcoder to the RTT call and can establish the RTT call, without the text (e.g., without the RTT media stream). The first server(s) 106 and the second server(s) 108 can establish the RTT call (without text) via various SIP communications (e.g., SIP 200 OK, SIP ACK, etc.). In additional and/or alternative examples, an alternative communications protocol can be used to register and establish the RTT call.

FIG. 2 illustrates an environment 200 for determining whether to assign a transcoder to a RTT call. As illustrated, the environment 200 includes the service provider 102, the alternate service provider 104, the first device 110, and the second device 112. The service provider 102, the alternate service provider 104, the first device 110, and the second device 112 can communicate via one or more networks 202. The network(s) 202 can comprise cellular network(s), the Internet, or other network(s).

In at least one example, the first device 110 and/or the second device 112 can correspond to user equipment (UE) including, but not limited to, a smart phone, a personal digital assistant, a netbook, a laptop computer, a smart appliance, and/or another electronic device that is capable of transmitting or receiving audio, video, and/or data via the network(s) 202. The first device 110 and/or the second device 112 can have the same or similar structures that perform the same or similar functions; however, for the sake of simplicity, details of the first device 110 are described below.

In at least one example, the first device 110 can include processor(s) 204, computer-readable media 206, and radio hardware 208. The processor(s) 204 can represent, for example, a central processing unit (CPU)-type processing unit, a graphics processing unit (GPU)-type processing unit, a Field-Programmable Gate Array (FPGA), another class of Digital Signal Processor (DSP), or other hardware logic components that can, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc. In at least one example, an accelerator can represent a hybrid device, such as one from ZYLEX or ALTERA that includes a CPU course embedded in an FPGA fabric. In various embodiments, the processor(s) 204 can execute one or more modules and/or processes to cause the first device 110 to perform a variety of functionalities, as set forth above and explained in further detail in the following disclosure. Additionally, each of the processor(s) 204 can possess its own local memory, which also can store program modules, program data, and/or one or more operating systems.

Depending on the exact configuration and type of the first device 110, the computer-readable media 206, can include computer storage media and/or communication media.

Computer storage media can include volatile memory, nonvolatile memory, and/or other persistent and/or auxiliary computer storage media, removable and non-removable computer storage media implemented in any method or technology for storage of information such as computer readable instructions, data structures, program modules, or other data. Computer memory is an example of computer storage media. Thus, computer storage media includes tangible and/or physical forms of media included in a device and/or hardware component that is part of a device or external to a device, including but not limited to random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, miniature hard drives, memory cards, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In at least one example, the computer storage media can include non-transitory computer-readable media. Non-transitory computer-readable media can include volatile and nonvolatile, removable and non-removable tangible, physical media implemented in technology for storage of information, such as computer readable instructions, data structures, program modules, or other data. The computer-readable media 206 is an example of non-transitory computer-readable media. Non-transitory computer-readable media include, but are not limited to, RAM, ROM, EEPROM, flash memory or other memory technology, CD-ROM, DVDs or other optical storage, magnetic cassettes, magnetic tape, magnetic disk storage or other magnetic storage devices, or any other tangible, physical medium which can be used to store the desired information and which can be accessed by the first device 110. Any such non-transitory computer-readable media can be part of the first device 110.

In contrast, communication media includes computer readable instructions, data structures, program modules, or other data in a modulated data signal, such as a carrier wave, or other transmission mechanism. As defined herein, computer storage media does not include communication media.

The computer-readable media 206 can include one or more modules and data structures including, for example, a device communication module 210 and a real-time text module 212. The one or more modules and data structures can be in the form of stand-alone applications, productivity applications, an operating system component, or any other application or software module configured to facilitate RTT calls between devices, as described herein.

The device communication module 210 can be configured to facilitate communications on behalf of the first device 110. That is, the device communication module 210 can transmit and/or receive calls, messages, and/or data on behalf of the first device 110. In at least one example, the device communication module 210 can be configured to transmit RTT calls on behalf of the first device 110. In such examples, the device communication module 210 can transmit combinations of media streams (e.g., RTT, audio, video, etc.) to one or more devices via the first server(s) 106 associated with the service provider 102.

In some examples, the device communication module 210 can transmit an offer to establish a RTT call with another device to the other device via respective service providers associated with the devices. The device communication module 210 can receive a response to the offer and can determine whether to establish the RTT call based on the response. As described above, in at least one example, the offer and response can be part of a registration process that utilizes SIP, or another communications protocol, to establish a communication session (e.g., an RTT call). Additional details are provided below.

The real-time text module 212 can be configured to provide RTT functionality for the first device 110. As described above, RTT describes the ability to instantly communicate text as it is typed, as opposed to after a sentence or thought is completed, in the manner of instant messaging. RTT can be signaled over IP networks and can be optionally combined in any combination with audio and/or video. In at least one example, a user of the first device 110 can enable and disable RTT functionality. For instance, the user can interact with a user interface to turn on RTT functionality for a portion of a call, a particular call, or for all calls. Similarly, the user can interact with a user interface to turn off RTT functionality for a portion of a call, a particular call, or for all calls. Details associated with device-side RTT implementation can be found in ATIS technical specification 0700029.

The real-time text module 212 can maintain the state of the RTT functionality for the first device 110. The state of the RTT functionality can indicate whether the RTT functionality for the first device 110 is enabled or disabled. In at least one example, if the RTT functionality of the first device 110 is disabled, the device communication module 210 can transmit a response to the first server(s) 106 indicating that an incoming offer to establish a RTT call is declined (e.g., not accepted) with an indicator (e.g., feature tag) indicating that the RTT functionality is disabled. That is, in an example where the RTT functionality of the first device 110 is disabled, the device communication module 210 can reject the offer and include an indication that the RTT functionality is disabled. The device communication module 210 can reject the offer by setting the port of the RTT media stream to zero. Accordingly, the device communication module 210 can transmit a response to the first server(s) 106 that indicates that the RTT media stream port is set to zero. In some examples, even though the device communication module 210 rejected the offer, the device communication module 210 can subsequently accept the audio and/or video media stream associated with the RTT call (while rejecting the RTT media stream) and the RTT call can continue using only audio and/or video. In examples where the RTT functionality of the first device 110 is enabled, the device communication module 210 can facilitate the RTT call by accepting the offer and subsequently accepting the audio and/or video media stream and the RTT media stream.

In an alternate example where a device is not RTT capable, the device lacks a real-time text module 212 and can return a response rejecting an offer that lacks a feature tag, as described below. For the purpose of this discussion, a device that is not RTT capable can be associated with an unsupported state.

The radio hardware 208 provides wireless UE capabilities, such as connecting to a base station associated with the service provider 102, a Wi-Fi network, or other wireless networks (e.g., network(s) 202). The radio hardware 208 can include or be incorporated into processors, ASICs, programmable circuits such as FPGAs, or in other ways.

As described above, the first device 110 and/or the second device 112 can have the same or similar structures that perform the same or similar functions. Accordingly, processor(s) 214 can have a same or similar structure and/or function as processor(s) 204, computer-readable media 216 can have a same or similar structure and/or function as computer-readable media 206, radio hardware 218 can have a same or similar structure and/or function as radio hardware 208, device communication module 220 can have a same or similar structure and/or function as device communication module 210. However, in at least one example, the second device 112 is not RTT capable, and accordingly lacks a real-time text module.

The service provider 102 can be associated with one or more first servers 106, as described above. Each of the first server(s) 106 can be any type of server, such as a network-accessible server. In various examples, each of the first server(s) 106 can be associated with one or more processors 24022, computer-readable media 224, and network hardware 226. The processor(s) 24022 can have the same and/or similar structure and/or function as the processor(s) 204, described above.

Depending on the exact configuration and type of the first server(s) 106, the computer-readable media 224 can include computer storage media and/or communication media. The computer-readable media 224 can have the same and/or similar structure and/or function as the computer-readable media 206, described above. The computer-readable media 224 can include one or more modules and data structures including, for example, a server communication module 228, a state determination module 230, and a transcoding module 232. The one or more modules and data structures can be in the form of stand-alone applications, productivity applications, an operating system component, or any other application or software module having data items that facilitate RTT communication, as described herein.

The server communication module 228 can be configured to facilitate communications on behalf of one or more devices that subscribe to services offered by the service provider 102 (e.g., first device 110, etc.). The server communication module 228 can receive calls, messages, and/or data from the first device 110 and can transmit the calls, messages, and/or data to other devices associated with the service provider 102 and/or devices associated with other service providers (e.g., alternate service provider 104). In at least one example, the server communication module 228 can be configured to transmit RTT calls on behalf of the first device 110. In such examples, the server communication module 228 can transmit combinations of media streams (e.g., RTT, audio, video, etc.) to other device(s) associated with the service provider 102 and/or to other service provider(s) to transmit to other devices.

Furthermore, in some examples, the server communication module 228 can receive calls, messages, and/or data from other device(s) and/or other service provider(s), and can transmit the calls, messages, and/or data to the first device 110 and/or other devices associated with the service provider 102. In at least one example, the server communication module 228 can be configured to receive RTT calls from other device(s) and/or service provider(s). In such examples, the server communication module 228 can transmit combinations of media streams (e.g., RTT, audio, video, etc.) to the first device 110 and/or other device(s) associated with the service provider 102.

In at least one example, the server communication module 228 can facilitate a registration process to establish a communication session. For instance, in at least one example, the server communication module 228 can receive an offer to establish a RTT call between the first device 110 and a second device 112 and can forward the offer to another service provider (e.g., the alternate service provider 104) associated with the second device 112. Then, the server communication module 228 can receive a response from the other service provider. The response can indicate whether the target device (e.g., the second device 112) accepts the offer or rejects the offer. In some examples, as described below, the response can include an indication of a state of RTT functionality associated with the second device 112. The server communication module 228 can utilize the response to determine whether to transcode the RTT call associated with the offer and/or for establishing the RTT call between the first device 110 and the second device 112. As described above, in some examples, the server communication module 228 can utilize SIP, or another communication protocol, to register and/or establish the RTT call.

The state determination module 230 can be configured to determine a state of RTT functionality associated with a device. In at least one example, a device can decline (e.g., not accept) an offer to establish an RTT call. In some examples, the device may support RTT but the device may have intentionally disabled (or refrained from enabling) RTT functionality. In such examples, the response indicating that the device declines the offer can include a feature tag indicating that the RTT functionality of the device has been disabled (and can hence eliminate the need for transcoding). In other examples, the device may not support RTT. That is, in such examples, the device may not be RTT capable. In such examples, the response lacks any indication of the state of RTT functionality associated with the device. That is, the response lacks a feature tag.

The state determination module 230 can access a response indicating that a device declined an offer. The state determination module 230 can determine whether the response is associated with a particular indication. If the response is associated with the indication, the state determination module 242 can determine that the device is associated with a disabled RTT state. If the response is not associated with the indication, the state determination module 242 can determine that the device is associated with an unsupported RTT state (e.g., the device is not RTT capable).

In at least one example, responsive to the state determination module 230 determining that the RTT functionality is in a disabled state, the state determination module 230 can forward the response, including the indication of the disabled state, to a service provider associated with the outgoing RTT call. In at least one example, responsive to the state determination module 230 determining that the device is not RTT capable (e.g., the device is in an unsupported RTT state), the state determination module 230 can add an indication to the response.

In at least one example, the indication can be a feature tag. The feature tag can be included in a particular header field (e.g., Contact header field) during RTT call registration and establishment. The presence of this feature tag allows the transcoding module 232 associated with the outgoing RTT call to refrain from assigning a transcoder to the RTT call. In some examples, the state determination module 230 can be associated with an interworking function that can determine that the RTT functionality is in a disabled state and/or add the feature tag to the response.

In some examples, if the response lacks an indicator, the state determination module 242 can utilize one or more criteria to analyze the response to determine whether the device may be TTY capable. In at least one example, the state determination module 242 can determine capabilities of the device and utilize the capabilities of the device to determine whether the device may be TTY capable. For instance, if the device is VoLTE capable, the state determination module 242 can determine that the device is not TTY capable. Or, if the device is GSM or UMTS capable, the state determination module 242 can determine that the device may be TTY capable. Additionally and/or alternatively, the state determination module 242 can determine a device type associated with the device, and can determine whether the device may support TTY based on the device type. If the device may be TTY capable, the state determination module 242 may refrain from adding an indicator (e.g., feature tag) to the response. Accordingly, the transcoding module 232 associated with the outgoing call may assign a transcoder to the RTT call.

As described above, in at least one example, the server communication module 228 can transmit a response indicating that an offer to establish a RTT call was not accepted by the target device. In some examples, the response can include an indication (e.g., a feature tag), which can indicate that RTT functionality associated with the target device was intentionally disabled (or not enabled) and/or the target device is not RTT (or TTY) capable.

The transcoding module 232 can be configured to assign a transcoder to an RTT call. In an example where the first server(s) 106 receive a response to an offer that does not include an indicator (e.g., a feature tag), the transcoding module 232 can convert the RTT call into another type of encoding. That is, the transcoding module 232 can assign a transcoder to the RTT call. In at least one example, the transcoding module 232 can be associated with an interworking function that can convert portions of an RTT call into a different encoding (e.g., Baudot or an equivalent). For instance, text in an RTT call can be coded in a common presentation protocol, ITU-T Recommendation T.140, and in at least one example, the common presentation protocol can be converted to any legacy mode character code used in other networks via the transcoding module 232 (e.g., Baudot tones). In at least one example, when transcoding is introduced by the transcoding module 232, the audio and/or video and RTT media streams can be transcoded to G.711 codec using Baudot nband tones along with possible audio.

The network hardware 226 can provide wired or wireless networking capabilities to the first server(s) 106. The network hardware 226 can include or be incorporated into processors, ASICs, programmable circuits such as FPGAs, or in other ways.

The alternate service provider 104 can be associated with one or more second servers 108, as described above. In various examples, each of the second server(s) 108 can be associated with one or more processors 234, computer-readable media 236, and network hardware 238. The processor(s) 234 can have the same and/or similar structure and/or function as the processor(s) 24022, described above. The computer-readable media 236 can have the same and/or similar structure and/or function as the computer-readable media 224. The network hardware 238 can have the same and/or similar structure and/or function as the network hardware 226. Like the computer-readable media 224, the computer-readable media 236 can include a server communication module 240, a state determination module 242, and a transcoding module 244. In at least one example, the server communication module 240 can have the same and/or similar structure and/or function as the server communication module 228, the state determination module 242 can have the same and/or similar structure and/or function as the state determination module 230, and the transcoding module 244 can have the same and/or similar structure and/or function as the transcoding module 232.

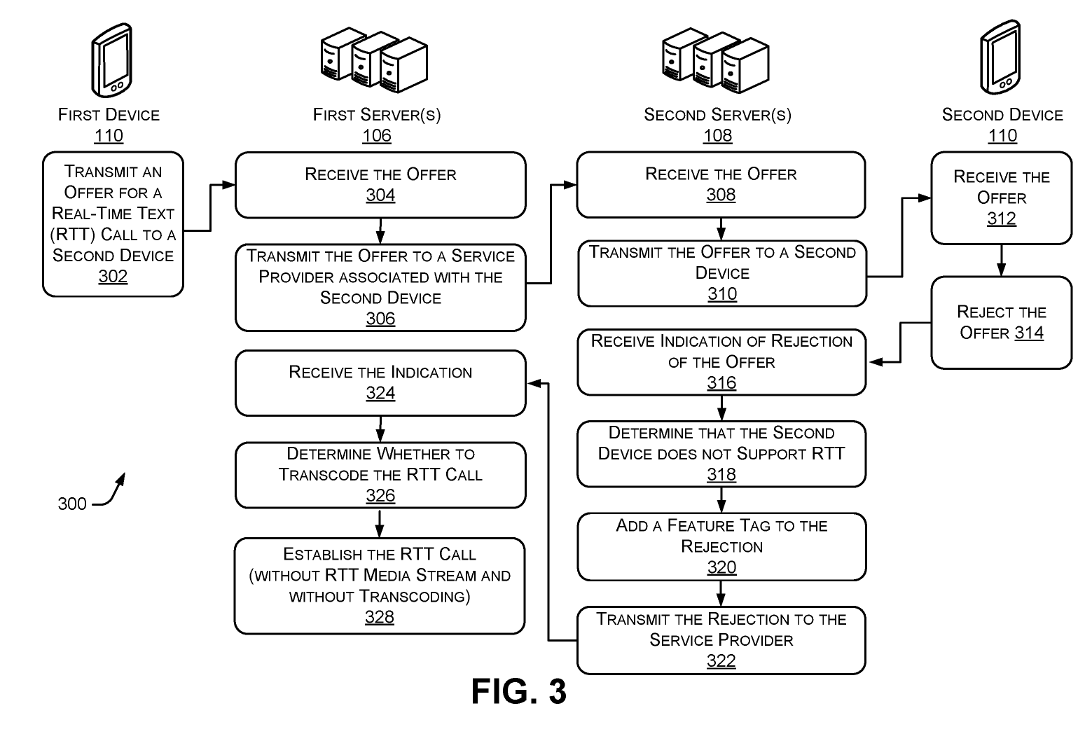

FIGS. 3-6 describe example processes for facilitating transcoder assignment for RTT. The example processes are described in the context of the environments of FIGS. 1 and 2, but are not limited to those environments.

The processes described above in association with FIGS. 3-6 can be implemented in hardware, software, or a combination thereof In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functionalities or implement particular abstract data types. In other embodiments, hardware components perform one or more of the operations. Such hardware components can include or be incorporated into processors, ASICs, programmable circuits such as FPGAs, or in other ways. The order in which the operations are described is not intended to be construed as a limitation, and any number of the described operations can be combined in any order and/or in parallel to implement the processes.

FIG. 3 illustrates an example process 300 for determining whether to assign a transcoder to a RTT call.

Block 302 illustrates transmitting, from a first device 110, an offer for a RTT call to a second device 112. In at least one example, the device communication module 210 can transmit an offer to establish a RTT call with another device to the other device via respective service providers associated with the devices. That is, in at least one example, the device communication module 210 can transmit an offer to establish a RTT call with the second device 112 to the second device 112 via the service provider 102 and the alternate service provider 104.

Block 304 illustrates receiving, at first server(s) 106, the offer and block 306 illustrates transmitting the offer to an alternate service provider associated with second server(s) 108. In at least one example, the server communication module 228 can facilitate a registration process prior to establishment of a call. For instance, in at least one example, the server communication module 228 can receive an offer to establish a RTT call between the first device 110 and a second device 112 and can forward the offer to the alternate service provider 104 associated with the second device 112.

Block 308 illustrates receiving, at the second server(s) 108, the offer, and block 310 illustrates transmitting the offer to the second device 112. In at least one example, the server communication module 240 can receive an offer to establish a RTT call between the first device 110 and a second device 112 and can forward the offer to the second device 112.

Block 312 illustrates receiving, at the second device 112, the offer. In at least one example, the device communication module 220 can receive the offer.

Block 314 illustrates rejecting the offer. In some examples, the second device 112 can reject the offer. For instance, the device communication module 220 can reject the offer because the second device 112 does not support RTT. In such examples, the device communication module 220 can transmit a response to the second server(s) 108 that it does not accept the offer. As described above, when a device is not RTT capable, the device lacks a real-time text module (e.g., the second device 112), and the response rejecting the offer lacks an indicator, such as a feature tag. Accordingly, because the second device 112 is not RTT capable, the device communication module 220 can transmit a response that lacks a feature tag to the second server(s) 108.

Block 316 illustrates receiving an indication of the rejection of the offer. In at least one example, the server communication module 240 can receive the response from the second device 112 indicating that the second device 112 declined an offer.

Block 318 illustrates determining that the second device 112 does not support RTT. Responsive to the server communication module 240 receiving the response indicating that the second device 112 declined the offer, the state determination module 242 can analyze the response to determine whether the response is associated with a feature tag. If the response is associated with a feature tag, the state determination module 242 can determine that the device is associated with a disabled RTT state. If the response is not associated with a feature tag, the state determination module 242 can determine that the device is associated with an unsupported RTT state (e.g., the device is not RTT capable). As illustrated in FIG. 3, the response is not associated with a feature tag and accordingly, the state determination module 242 can determine that the second device 112 does not support RTT.

Block 320 illustrates adding a feature tag to the rejection. In at least one example, responsive to the state determination module 242 determining that the device is not RTT capable (e.g., the device is in an unsupported RTT state), the state determination module 242 can add an indication, such as a feature tag, to the response. As described above, a feature tag can be included in a particular header during RTT call registration and establishment. The presence of this feature tag allows the transcoding module associated with the outgoing RTT call to refrain from assigning a transcoder to the RTT call. In some examples, the state determination module 242 can be associated with an interworking function that can determine that the device is not capable of RTT and/or add the feature tag to the response.

Block 322 illustrates transmitting an indication of rejection of the offer (and the feature tag) to the service provider associated with the first server(s) 106. In at least one example, the server communication module 240 can transmit a response indicating that the offer to establish an RTT call was not accepted by the second device 112. Because the second device 112 does not support RTT, the response can include the feature tag indicating that the second device 112 does not support RTT.

Block 324 illustrates receiving, at the first server(s) 106, the indication. In at least one example, the server communication module 228 can receive the response.

Block 326 illustrates determining whether to transcode the RTT call. In at least one example, the state determination module 230 can analyze the response to determine whether a feature tag is appended to the response. If the response is associated with a feature tag, the state determination module 230 can refrain from transmitting an instruction to the transcoding module 232 and can transmit an instruction to the server communication module 228 to establish the RTT call. In an alternate example (e.g., not illustrated in FIG. 3), if the response is not associated with a feature tag, the state determination module 230 can transmit an instruction to the transcoding module 232 to assign a transcoder to the RTT call and can transmit an instruction to the server communication module 228 to establish the RTT call (with the transcoder).

Block 328 illustrates establishing the RTT call (without RTT media stream and without transcoding). The server communication module 228 can establish the RTT call. In examples where a transcoder is not required, the server communication module 228 can establish the RTT call without the transcoder (and without the RTT media stream). That is, the server communication module 228 can transmit the audio and/or video media stream to the server communication module 240, which can transmit the audio and/or video media stream to the device communication module 220 to establish the RTT call. That is, the RTT call can be established with the audio and/or video media stream and without the text associated with the RTT media stream.

In an alternative example, where a transcoder is required (not illustrated in FIG. 3), the server communication module 228 can establish the RTT call with the transcoder.

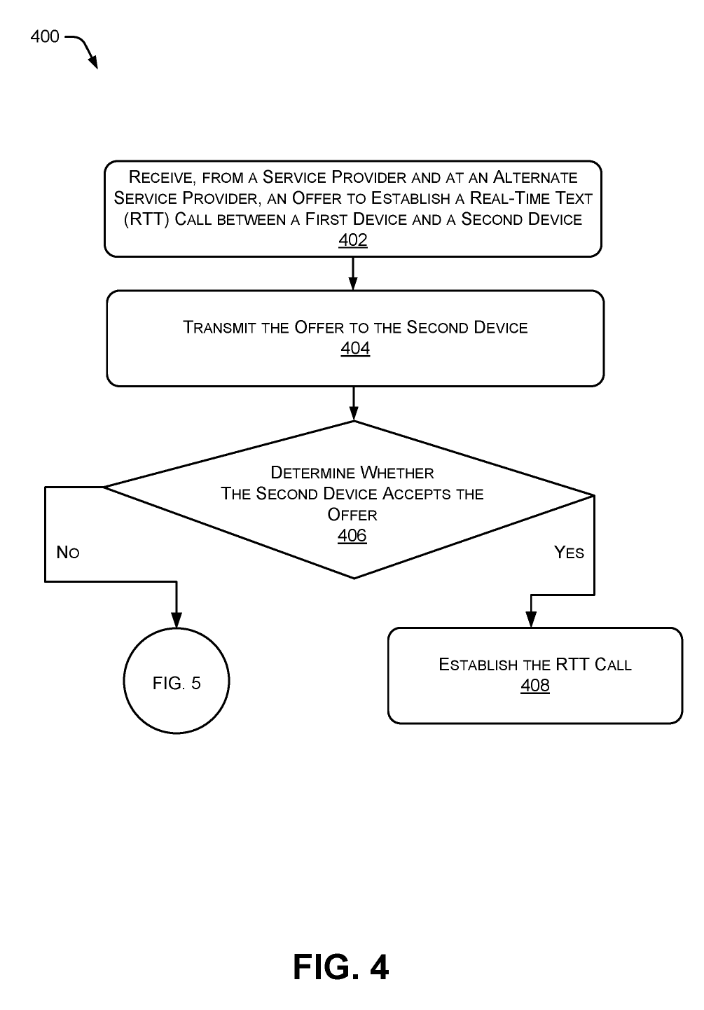

FIG. 4 illustrates an example process 400, performed by a service provider, for determining whether a target device accepts an offer for a RTT call.

Block 402 illustrates receiving, from a service provider 102 and at an alternate service provider 104, an offer to establish a RTT call between a first device 110 and a second device 112. In at least one example, the server communication module 240 associated with the second server(s) 108 can receive the offer.

Block 404 illustrates transmitting the offer to the second device 112. In at least one example, the server communication module 240 can transmit the offer to the second device 112.

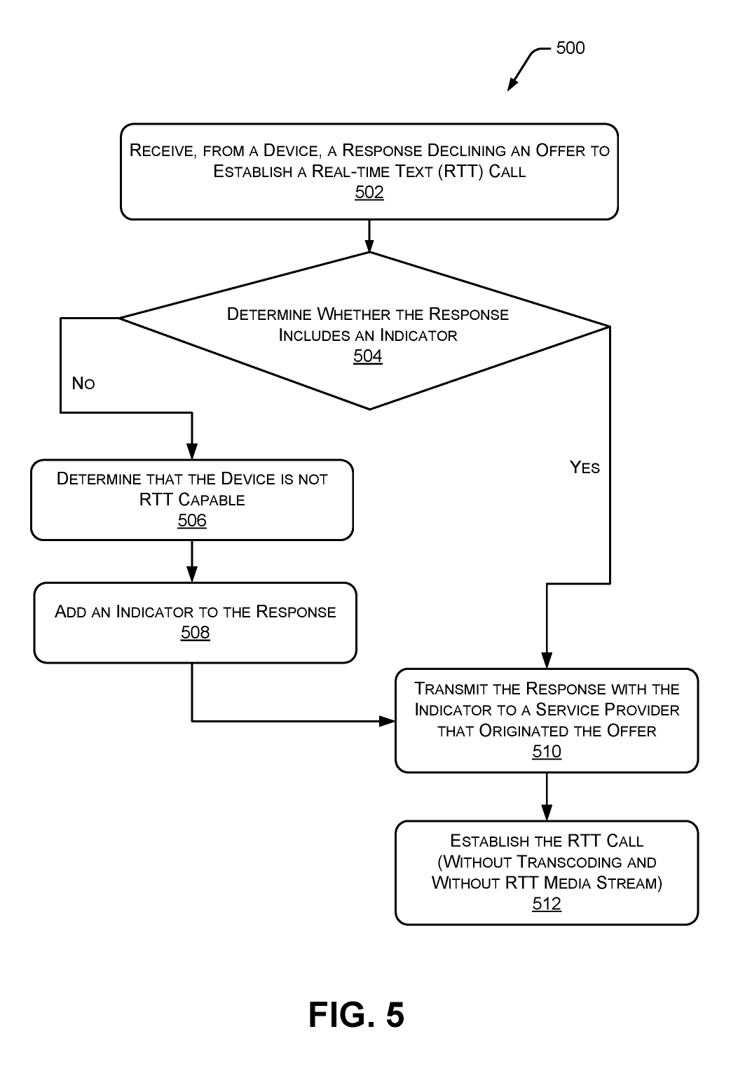

Block 406 illustrates determining whether the second device 112 accepts the offer. As described above, in some examples, the second device 112 can reject the offer. For instance, the second device 112 can reject the offer because the second device 112 does not support RTT. Or, the second device 112 can reject the offer because the RTT functionality on the second device 112 is disabled. In such examples, the device communication module 220 can transmit a response to the second server(s) 108 indicating that it does not accept the offer. Based at least in part on determining that the second device 112 rejects the offer, process 400 can continue as described in FIG. 5. Based at least in part on the second device 112 accepting the offer to establish an RTT call, the server communication module 240 can establish the RTT call between the first device 110 and the second device 112, as illustrated in block 408.

FIG. 5 illustrates an example process 500, performed by a service provider, for determining whether a device supports RTT functionality and sending a response indicating whether a device supports RTT functionality.

Block 502 illustrates receiving, from a device, a response to an offer to establish a RTT call. As described above, in at least one example, the server communication module 240 associated with the second server(s) 108 can receive the offer from the server communication module 228 associated with the first server(s) 106. In at least one example, the server communication module 240 can transmit the offer to the second device 112. As described above, in some examples, the second device 112 can reject the offer. For instance, the second device 112 can reject the offer because the second device 112 is not configured to receive RTT calls in such an encoding or the RTT functionality on the second device 112 is disabled. In such examples, the device communication module 220 can transmit an indication to the second server(s) 108 that it does not accept the offer. In at least one example, the server communication module 240 can receive a response that the second device 112 declined an offer.

In an example where the second device 112 is RTT capable, but the RTT functionality is disabled, the response can include an indicator, such as a feature tag. In an example where the second device 112 is not RTT capable, the response can lack an indicator, such as a feature tag.

Block 504 illustrates determining whether the response includes an indicator. Responsive to the server communication module 240 receiving the response indicating that the second device 112 declined the offer, the state determination module 242 can analyze the response to determine whether the response is associated with an indicator, such as a feature tag. If the response is associated with a feature tag, the state determination module 242 can determine that the second device 112 is associated with a disabled RTT state. If the response is not associated with a feature tag, the state determination module 242 can determine that the second device 112 is associated with an unsupported RTT state (e.g., the device is not RTT capable).

Block 506 illustrates determining that the device is not RTT capable. Based at least in part on determining that the response is not associated with a feature tag, the state determination module 242 can determine that the second device 112 does not support RTT.

Block 508 illustrates adding an indicator to the response. In at least one example, responsive to the state determination module 242 determining that the device is not RTT capable (e.g., the device is in an unsupported RTT state), the state determination module 242 can add an indication to the response. As described above, the indication can be a feature tag, which can be included in a particular header during RTT call registration and establishment. The presence of this feature tag allows the transcoding module associated with the outgoing RTT call to refrain from assigning a transcoder to the RTT call. In some examples, the state determination module 242 can be associated with an interworking function that can determine that the device is not capable of RTT and/or add the feature tag to the response.

Block 510 illustrates transmitting the response and the indicator to a service provider that originated the offer. In at least one example, the server communication module 240 can transmit a response indicating that the offer to establish an RTT call was not accepted by the second device 112 to the state determination module 230 associated with the first server(s) 106. The response can include the feature tag indicating that the second device 112 does not support RTT.

Based at least in part on determining that the response includes an indicator, such as a feature tag, the server communication module 240 can transmit the response with the indicator to the state determination module 230 associated with the first server(s) 106, as illustrated in block 510. In such an example, the indicator can be a feature tag indicating the RTT functionality associated with the second device 112 is disabled.

The feature tag, whether added or received by the state determination module 242, can enable the transcoding module 232 associated with the first server(s) 106 to refrain from assigning a transcoder to the RTT call. The server communication module 228 can receive the response with the indicator and can determine whether a transcoder is required to establish the RTT call. In examples where a transcoder is not required, the server communication module 228 can establish the RTT call without the transcoder (and without the RTT media stream). That is, the server communication module 228 can transmit the audio and/or video media stream to the server communication module 240, which can transmit the audio and/or video media stream to the device communication module 220 to establish the RTT call, as illustrated in block 512. That is, the RTT call can be established with the audio and/or video media stream and without the text associated with the RTT media stream.

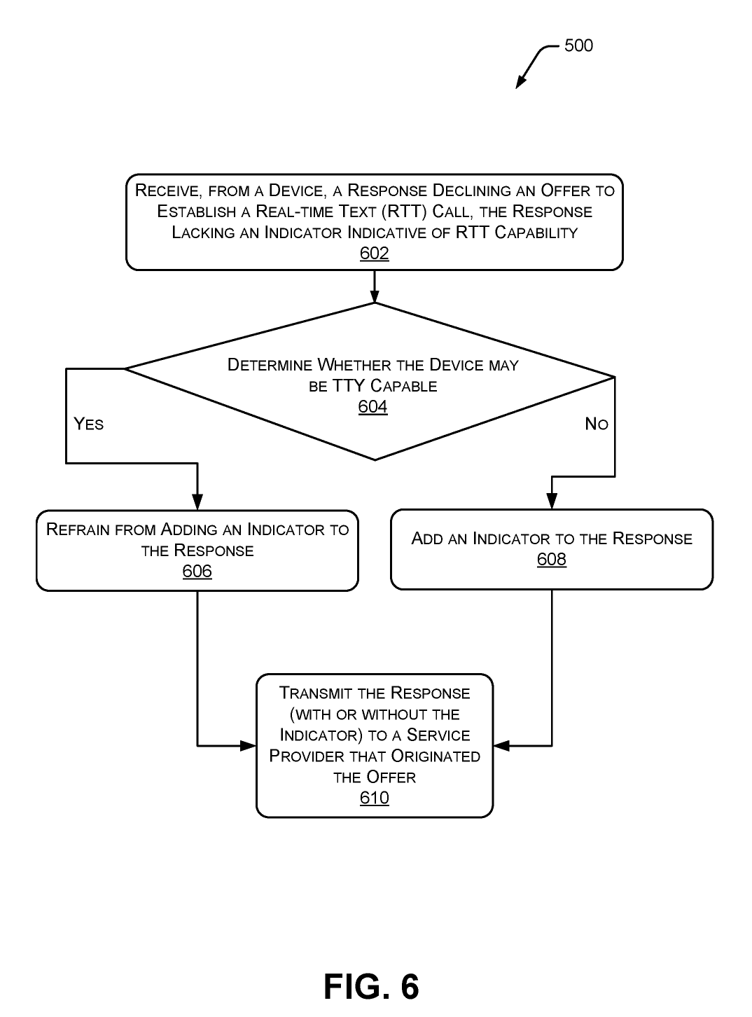

FIG. 6 illustrates an example process 600, performed by a service provider, for determining whether to add a feature tag to a response declining an offer to establish an RTT call.

Block 602 illustrates receiving, from a device, a response to an offer to establish a RTT call, the response lacking an indicator indicative of RTT capability. As described above, in at least one example, the server communication module 240 associated with the second server(s) 108 can receive the offer from the server communication module 228 associated with the first server(s) 106. In at least one example, the server communication module 240 can transmit the offer to the second device 112. As described above, in some examples, the second device 112 can reject the offer. For instance, the second device 112 can reject the offer because the second device 112 is not configured to receive RTT calls in such an encoding or the RTT functionality on the second device 112 is disabled. In such examples, the device communication module 220 can transmit an indication to the second server(s) 108 that it does not accept the offer. In at least one example, the server communication module 240 can receive a response that the second device 112 declined an offer.

As described above, responsive to the server communication module 240 receiving the response indicating that the second device 112 declined the offer, the state determination module 242 can analyze the response to determine whether the response is associated with an indicator, such as a feature tag. Based at least in part on determining that the response is not associated with a feature tag, the state determination module 242 can determine that the second device 112 does not support RTT.

Block 604 illustrates determining whether the device may be TTY capable. In some examples, if the response lacks an indicator, the state determination module 242 can utilize one or more criteria to analyze the response to determine whether the device may be TTY capable. In at least one example, the state determination module 242 can determine capabilities of the device and utilize the capabilities of the device to determine whether the device may be TTY capable. For instance, if the device is VoLTE capable, the state determination module 242 can determine that the device is not TTY capable. Or, if the device is GSM or UMTS capable, the state determination module 242 can determine that the device may be TTY capable. Additionally and/or alternatively, the state determination module 242 can determine a device type associated with the device, and can determine whether the device may support TTY based on the device type.

Based at least in part on determining that the device may be TTY capable, the state determination module 242 may refrain from adding an indicator (e.g., a feature tag) to the response, as illustrated in block 606. Accordingly, the transcoding module 232 associated with the outgoing call may assign a transcoder to the RTT call.

Based at least in part on determining that the device in not TTY capable, the state determination module 242 may add an indicator (e.g., a feature tag) to the response, as illustrated in block 608. Accordingly, the transcoding module 232 associated with the outgoing call may refrain from assigning a transcoder to the RTT call.

Block 610 illustrates transmitting the response (with or without the indicator) to a service provider that originated the offer. In at least one example, the server communication module 240 can transmit a response indicating that the offer to establish an RTT call was not accepted by the second device 112 to the first server(s) 106. If the second device 112 does not support RTT and TTY, the response can include the feature tag indicating that the second device 112 does not support RTT and TTY. As described above, if the response is associated with a feature tag, the state determination module 230 associated with the first server(s) 106 can refrain from transmitting an instruction to the transcoding module 232 and can transmit an instruction to the server communication module 228 to establish the RTT call. If the device 112 does not support RTT, but may support TTY, the response can lack the feature tag. As described above, if the response is not associated with a feature tag, the state determination module 230 can transmit an instruction to the transcoding module 232 to assign a transcoder to the RTT call and can transmit an instruction to the server communication module 228 to establish the RTT call (with the transcoder).

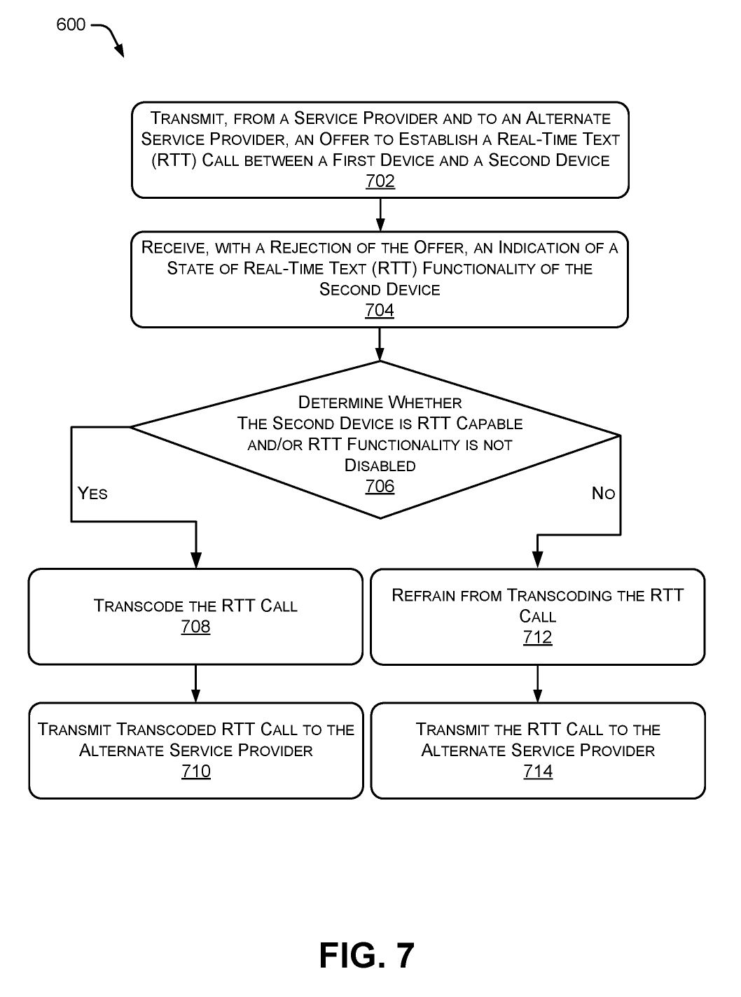

FIG. 7 illustrates an example process 700, performed by a service provider, for determining whether to assign a transcoder to a RTT call based on an indication of a state of RTT functionality associated with a target device.

Block 702 illustrates transmitting, from a service provider 102 and to an alternate service provider 104, an offer to establish a RTT call between a first device 110 and a second device 112. In at least one example, the device communication module 210 associated with a first device 110 can transmit an offer to establish a RTT call with a second device 112 to the second device 112 via the service provider 102 and the alternate service provider 104. In at least one example, the server communication module 228 can receive the offer to establish the RTT call between the first device 110 and a second device 112 and can forward the offer to the alternate service provider 104 associated with the second device 112.

Block 704 illustrates receiving, with a rejection of the offer, an indication of a state of RTT functionality of the second device 112. As described above, in at least one example, the server communication module 240 associated with the second server(s) 108 can receive the offer from the server communication module 228 associated with the first server(s) 106. In at least one example, the server communication module 240 can transmit the offer to the second device 112. As described above, in some examples, the second device 112 can reject the offer. For instance, the second device 112 can reject the offer because the second device 112 is not configured to receive RTT calls in such an encoding or the RTT functionality on the second device 112 is disabled. In such examples, the device communication module 220 can transmit an indication to the second server(s) 108 that it does not accept the offer. In at least one example, the server communication module 240 can receive an indication that the second device 112 declined an offer. Based at least in part on determining that the second device 112 rejects the offer, the state determination module 242 can determine whether the second device 112 rejected the offer because it does not support RTT or because the RTT functionality is disabled (based on the presence or absence of a feature tag associated with the response).

As described above, if the second device 112 either is not RTT capable (and TTY capable) and/or RTT is disabled, the response can be associated with a feature tag. The feature tag can be included in a particular header field (e.g., Contact header field) during RTT call registration and establishment. The presence of this feature tag allows the transcoding module 232 associated with the outgoing RTT call to determine not to assign a transcoder to the RTT call. In at least one example, the server communication module 240 can transmit a response indicating that the offer to establish an RTT call was not accepted by the second device 112. If the second device 112 does not support RTT (or TTY), or the RTT functionality was intentionally disabled (or not enabled), the response can include the feature tag indicating the disabled state of the RTT functionality associated with the second device 112.

The server communication module 228 of the first server(s) 106 can receive the response from the server communication module 240 of the second server(s) 108.

Block 706 illustrates determining whether the second device 112 is RTT capable and/or RTT functionality is not disabled. The state determination module 230 associated with the first server(s) 106 can access the response and can determine whether the response is associated with an indicator. If the response is associated with an indicator, the state determination module 230 can determine that the second device 112 either does not support RTT (or TTY) or that the RTT functionality of the second device 112 is disabled (or not enabled). If the response is not associated with an indicator, the state determination module 230 can determine that the second device 112 supports RTT (or may support TTY) and/or the RTT functionality of the second device 112 is enabled.

Block 708 illustrates transcoding the RTT call. If the response is not associated with an indicator, the state determination module 230 can send an instruction to the transcoding module 232 to assign a transcoder to the RTT call. That is, based on receiving an instruction from the state determination module 230, the transcoding module 232 can convert the RTT call into another type of encoding. In at least one example, the transcoding module 232 can be associated with an interworking function that can convert portions of an RTT call into a different encoding (e.g., Baudot or an equivalent). For instance, text in an RTT call can be coded in a common presentation protocol, ITU-T Recommendation T.140, and in at least one example, the common presentation protocol can be converted to any legacy mode character code used in other networks via the transcoding module 232 (e.g., Baudot tones). In at least one example, when transcoding is introduced by the transcoding module 232, the audio and/or video and RTT media streams can be transcoded to G.711 codec using Baudot nband tones along with possible audio.

Block 710 illustrates transmitting the transcoded RTT call to the alternate service provider 104. Based at least in part on assigning a transcoder to the RTT call, the server communication module 228 can establish the RTT call with the alternate service provider 104. In such an example, the server communication module 228 can transmit the transcoded RTT call (e.g., audio and/or video media stream and RTT media stream) to the server communication module 240 associated with the alternate service provider 104, which can transmit the transcoded RTT call to the second device 112 to establish the RTT call.

Block 712 illustrates refraining from transcoding the RTT call. In at least one example, the state determination module 230 can analyze the response to determine whether the indicator is appended to the response. If the response is associated with an indicator, the state determination module 230 can refrain from transmitting an instruction to the transcoding module 232. That is, the state determination module 230 can determine not to transmit an instruction to the transcoding module 232 to transcode the RTT call. Accordingly, the state determination module 230 can transmit an instruction to the server communication module 228 to establish the RTT call.

Block 714 illustrates transmitting the RTT call to the alternate service provider 104. In such an example, the server communication module 228 can transmit the audio and/or video media stream of the RTT call to the server communication module 240 associated with the alternate service provider 104, which can transmit the audio and/or video media stream to the second device 112 to establish the RTT call sans the RTT media stream.

Although the subject matter has been described in language specific to structural data items and/or methodological acts, it is to be understood that the subject matter defined in the appended claims is not necessarily limited to the specific data items or acts described. Rather, the specific data items and acts are disclosed as exemplary forms of implementing the claims.

What is claimed is:

1. A system comprising one or more first servers associated with a service provider, the one or more first servers including:
one or more first processors; and
one or more first computer-readable media storing first instructions executable by the one or more first processors, wherein the first instructions program the one or more first processors to:
receive, from a first device that subscribes to first services available from the service provider, an offer to establish a real-time text (RTT) call with a second device that subscribes to second services available from an alternate service provider;
transmit the offer to the alternate service provider;
receive, from the alternate service provider, a first indication that the second device declined the offer and a second indication that the second device does not support RTT, the second indication associated with the first indication by the alternate service provider; and
determine not to transcode the RTT call based at least in part on the indication.

2. The system as claim 1 recites, further comprising one or more second servers associated with the alternate service provider, the one or more second servers including:
one or more second processors; and
one or more second computer-readable media storing second instructions executable by the one or more second processors, wherein the second instructions program the one or more second processors to:
receive, from the service provider, the offer;
transmit the offer to the second device;
receive, from the second device, the first indication that the second device does not accept the offer;
determine, based at least in part on the first indication, that the second device does not support RTT;
associate the second indication with the first indication; and
transmit the first indication and the second indication to the service provider.

3. The system as claim 2 recites, wherein the one or more second servers further include an interworking function to determine that the second device does not support RTT.

4. The system as claim 3 recites, wherein the interworking function determines that the second device does not support RTT based at least in part on:
analyzing the first indication to determine whether the first indication is associated with a third indication indicating that RTT functionality associated with the second device is disabled; and
determining that the first indication does not include the third indication.

5. The system as claim 1 recites, wherein the second indication is a feature tag.

6. The system as claim 1 recites, wherein the service provider and the alternate service provider are partner service providers.

7. The system as claim 1 recites, wherein the service provider or the alternate service provider is a non-internet protocol multimedia subsystem (IMS)-enabled emergency services service provider.

8. A computer-implemented method performed by one or more servers of a service provider, the computer-implemented method comprising:
receiving, from a first device that subscribes to first services available from the service provider, an offer to establish a real-time text (RTT) call with a second device that subscribes to second services available from an alternate service provider;
transmitting the offer to the alternate service provider;
receiving, from the alternate service provider and responsive to the offer, an indication of a state of RTT functionality associated with the second device, the state of the RTT functionality being determined by the alternate service provider; and
determining whether to transcode the RTT call based at least in part on the state of the RTT functionality.

9. The computer-implemented method as claim 8 recites, wherein the indication indicates that the second device declined the offer and includes a feature tag indicating that the state of the RTT functionality is associated with an unsupported state, the feature tag added by the alternate service provider.

10. The computer-implemented method as claim 9 recites, further comprising determining not to transcode the RTT call based at least in part on the state of the RTT functionality.

11. The computer-implemented method as claim 8 recites, wherein the indication indicates that the second device declined the offer and either (i) RTT functionality associated with the second device is not in a disabled state or (ii) the second device supports teletypewriter (TTY) services.

12. The computer-implemented method as claim 11 recites, further comprising determining to transcode the RTT call based at least in part on the indication.

13. The computer-implemented method as claim 8 recites, wherein the indication comprises a feature tag that is added, by the alternate service provider, to a response declining the offer to establish the RTT call.

14. A computer-implemented method comprising:
receiving, from a service provider and at an alternate service provider, an offer to establish a real-time text (RTT) call with a first device that supports RTT;
transmitting the offer to a second device associated with the alternate service provider;
determining that the second device does not accept the offer;
determining whether the second device supports RTT; and
transmitting a first response indicating that the second device rejected the offer to the service provider, the first response indicating that the second device does not support RTT.

15. The computer-implemented method as claim 14 recites, further comprising:
receiving, from the second device, a second response indicating that the second device does not accept the offer;
analyzing the second response to determine whether the second response is associated with a first indication that RTT functionality associated with the second device is disabled;
determining that the second response lacks the first indication; and
determining that the second device does not support RTT based on the second response lacking the first indication.

16. The computer-implemented method as claim 15 recites, further comprising associating a second indication with the response, the second indication indicating that the second device does not support RTT.

17. The computer-implemented method as claim 16 recites, wherein the second indication is a feature tag.

18. The computer-implemented method as claim 16 recites, further comprising:
analyzing one or more criteria associated with the first response to determine that the second device does not support teletypewriter (TTY) services; and
associating the second indication based at least in part on determining that the second device does not support TTY services or RTT.

19. The computer-implemented method as claim 18 recites, wherein the one or more criteria includes a cellular technology supported by the second device.

20. The computer-implemented method as claim 14 recites, further comprising establishing, responsive to transmitting the response to the service provider, the RTT call without a transcoder.
